(19) United States
(12) Patent Application Publication
(10) Pub. No.: US 2017/0330426 A1
(43) Pub. Date: Nov. 16, 2017

(54) ARRANGEMENT FOR, AND METHOD OF, PROCESSING PRODUCTS ASSOCIATED WITH RFID TAGS AND BAR CODE SYMBOLS IN THE SAME WORKSTATION

(71) Applicant: SYMBOL TECHNOLOGIES, LLC, LINCOLNSHIRE, IL (US)

(72) Inventors: REHAN K. JAFFRI, NEW YORK, NY (US); MARK E. DRZYMALA, ST. JAMES, NY (US); EDWARD D. BARKAN, MILLER PLACE, NY (US)

(21) Appl. No.: 15/150,550

(22) Filed: May 10, 2016

(51) Int. Cl. G07G 1/00; G06K 7/10; G06K 19/077; G06Q 20/20

(52) U.S. Cl. CPC G07G 1/009; G06Q 20/208; G06K 7/10742; G06K 19/07758

(57) ABSTRACT

The same workstation supports an electro-optical reader for reading bar code symbols, and a radio frequency (RF) antenna of an RF identification (RFID) reader for reading RFID tags, through a window that is transmissive to light and to RF energy. The RF antenna is mounted in an interior cavity of the workstation that is bounded by electrically conductive walls and the window. An RF reflector behind the RF antenna reflects the RF energy radiated by the RF antenna out of the interior cavity through the window along a direction generally perpendicular to the window.

### BACKGROUND OF THE INVENTION

The present disclosure relates generally to an arrangement for, and a method of, processing products associated with bar code symbols and/or radio frequency (RF) identification (RFID) tags, and, more particularly, to a point-of-transaction, checkout workstation through which the products are passed and processed, while the associated symbols and/or RFID tags are read by the same workstation.

In the retail industry, it is known to read targets, such as one-dimensional bar code symbols, particularly of the Universal Product Code (UPC) type, and two-dimensional bar code symbols, such as Quick Response (QR) codes, associated with, or borne on, retail products or items that are passed through, and processed by, various types of workstations, such as a flat bed scanner having a single horizontal window, or a vertical slot scanner having a single upright window, or a bi-optical scanner having dual horizontal and upright windows. Each such workstation can have either laser-based or imager-based readers for electro-optically reading the symbols passed by, or presented to, either or both windows, and each such workstation is typically fixedly installed and stationarily mounted in a checkout counter.

RFID systems for reading targets are also known and are commonly utilized for product locating, product tracking, product identification, and inventory control in manufacturing, warehouse, retail environments, and like venues. Briefly, an RFID system includes two primary components: an RFID reader (also known as an interrogator), and an RFID tag (also known as a transponder). The tag is a miniature device associated with, or attached to, a product to be monitored and is capable of responding, via a tag antenna, to an electromagnetic RF interrogating wave wirelessly propagated by an RF antenna of the reader. The tag responsively generates and wirelessly propagates an electromagnetic RF return wave back to the reader antenna. The return wave is modulated in a manner that conveys identification data (also known as a payload) from the tag back to the reader. The identification data can then be stored, processed, displayed, or transmitted by the RFID reader as needed.

It has become increasingly common in some venues to provide RFID tags in close proximity to symbols on products, or on shipping cartons containing the products, or on transport pallets that support the products and/or cartons, because the RFID reader can complement the symbol reader in reducing time and labor involved in a number of locating, tracking, identification, and inventory control processes, and can also provide a higher level of accuracy as compared to only relying on the symbol reader when implemented in certain areas of the venue. One such area is checkout, where an electro-optical symbol reader in a stationary workstation is operated to read symbols, and where a separate RFID reader is separately operated to read RFID tags. The RFID reader can advantageously confirm that the products being checked out should be removed from inventory. The RFID reader and the symbol reader are typically contained in separate housings that are remote from each other. For example, the RFID reader can be stationarily mounted overhead on a ceiling of the venue above the workstation, or the RFID reader can be implemented as a portable, mobile device that is movable towards and away from the workstation. The mobile device is typically supported in an operator's hand during use, or is mounted either directly, or in a cradle mounted, on the counter, during non-use.

Although the known symbol and RFID readers are generally satisfactory for their intended reading purposes, the operator needs to operate two different readers at two different times. This not only requires a skilled operator, but also slows down the checkout process, which is undesirable not only from the retailer's, but also from the customer's, point of view. The workstation typically has a housing principally constituted of metal walls that form a metallic chassis. Heretofore, the RFID reader, and particularly its RF antenna, was not integrated with the symbol reader in the same workstation, because the metal housing walls would attenuate, or sometimes even block, the RF interrogating and return waves, thereby degrading the tag reading performance.

Accordingly, it would be desirable to integrate a symbol reader and an RF antenna of an RFID reader in the same workstation, to enable the same workstation to read both symbols and/or RFID tags despite the metal walls of the workstation, and to expedite the overall checkout process.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic, overhead view of a bi-optical workstation at a retail checkout counter, the workstation being equipped with a bar code symbol reader and with an RFID reader in accordance with the present disclosure.

FIG. 2 is a perspective, more realistic view of the workstation of FIG. 1 in isolation.

FIG. 3 is a perspective, exploded, miniature view depicting how an RF antenna of the RFID reader is installed in the workstation of FIG. 2.

FIG. 4 is a perspective, exploded, enlarged view of the rectangular dashed area “A” of FIG. 3.

FIG. 5 is a sectional view of the workstation of FIG. 2.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement, workstation, and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of the present disclosure generally relates to an arrangement or workstation for processing products associated with targets to be read as they pass through the workstation. The workstation includes a window constituted of a material, such as glass or plastic, transmissive to light and to radio frequency (RF) electromagnetic energy, particularly at a frequency greater than 900 MHz, and a housing or chassis for supporting the window. The housing has housing walls constituted of a material, such as metal, that reflects the RF energy. An electro-optical reader is supported by the housing and is operative for reading the targets configured as bar code symbols by detecting return light returning from the symbols and passing through the window. An RF identification (RFID) reader includes an RF antenna supported by the housing and operative for radiating the RF energy in the industrial, scientific, and medical (ISM) frequency band of about 902 MHz to about 928 MHz. The RFID reader is operative for reading the targets configured as RFID tags by directing the radiated RF energy reflected by the housing walls through the window away from the housing, and by detecting return RF energy returning from the tags toward the housing through the window.

Advantageously, the RF antenna can be a loop antenna, a dipole, or a like radiator, and is mounted in an interior cavity of the housing that is bounded by the housing walls and the window. The RF antenna is mounted behind the window and, when configured as a loop, surrounds the window. The material of the housing walls is electrically conductive to reflect the radiated RF energy away from the interior cavity through the window. An RF reflector is preferably provided behind the RF antenna, and is operative for reflecting the radiated RF energy through the window along a direction that is generally perpendicular to the window, thereby configuring the RF antenna as a directional antenna. The RF reflector may be one of the electrically conductive housing walls, e.g., a bottom wall or a back wall, or may be a discrete, electrically conductive, metal plate mounted inside or outside the housing.

In a preferred embodiment, the workstation is a bi-optical workstation whose housing includes a horizontal bed for supporting the window, and an upright raised tower for supporting another window that is also transmissive to the light and to the RF energy. The RF antenna is mounted behind at least one of the windows. The RFID reader includes an RF control module that may be mounted inside or outside the housing. The RF control module controls a transmit power of a transceiver connected to the RF antenna to limit the effective radiated power (ERP) so that the RF antenna radiates the RF energy over a reading zone of limited range relative to at least one of the windows. The electro-optical reader is operative for reading the symbols over a reading field, and the RFID reader is operative for reading the RFID tags over a reading zone that preferably at least partly overlaps the reading field.

Still another aspect of the present disclosure relates to a method of processing products associated with targets to be read. The method is performed by constituting a window of a material transmissive to light and to radio frequency (RF) electromagnetic energy at a frequency greater than 900 MHz, by supporting the window on a housing having housing walls, by constituting the housing walls of a material that reflects the RF energy, by reading the targets configured as bar code symbols with an electro-optical reader supported by the housing by detecting return light returning from the symbols and passing through the window, and by reading the targets configured as RFID tags with an RF identification (RFID) reader having an RF antenna supported by the housing by directing the RF energy radiated by the RF antenna and reflected by the housing walls through the window away from the housing, and by detecting return RF energy returning from the tags toward the housing through the window.

In accordance with this disclosure, a symbol reader and at least an RF antenna of an RFID reader are both integrated in the same workstation, and the same workstation can read both symbols and/or RFID tags despite the metal walls of the workstation. The overall checkout process is expedited, because the symbol and RFID readers are not separately operated at two different times. In fact, both the symbols and the RFID tags can be simultaneously read.

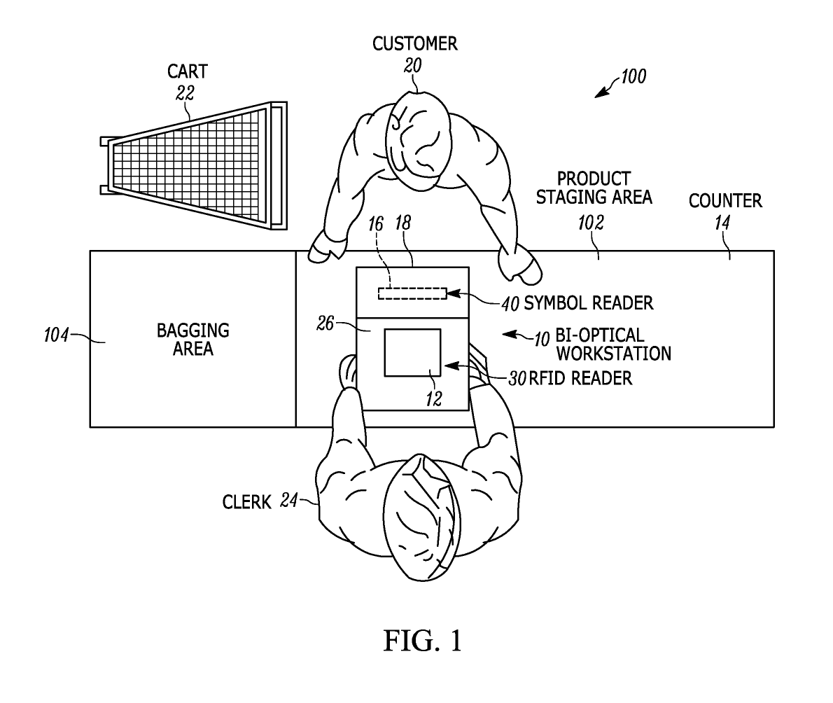

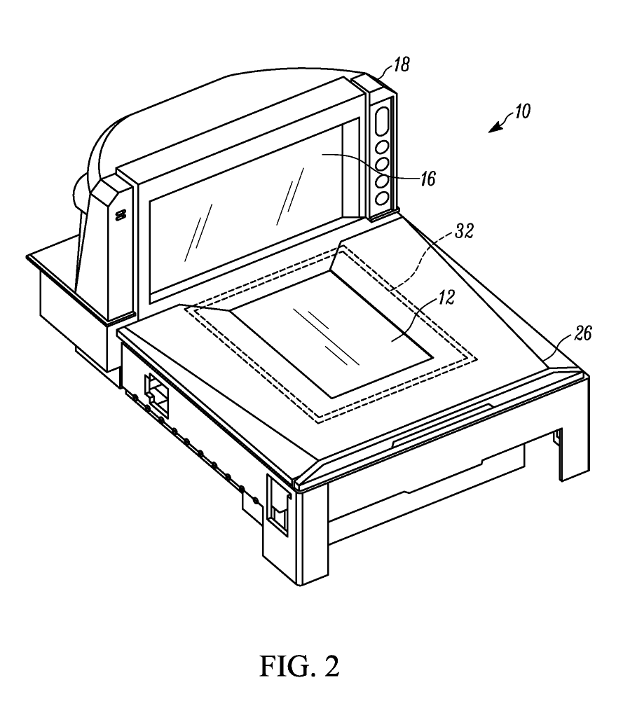

Turning now to the drawings, a retail checkout system 100, as depicted in FIG. 1, includes a dual window, multi-plane, bi-optical, point-of-transaction, retail workstation 10 used by retailers at a retail checkout counter 14 in an aisle to process transactions involving the purchase of retail products associated with, or bearing, an identifying target, such as the symbols described above. In a typical retail venue, a plurality of such workstations 10 is arranged in a plurality of checkout aisles. As best seen in FIG. 2, the workstation 10 has a generally horizontal, planar, generally rectangular, bed window 12 supported by a horizontal bed 26. The bed window 12 is either elevated, or set flush, with the counter 14. A vertical or generally vertical, i.e., slightly tilted, (referred to as “upright” hereinafter) planar, generally rectangular, tower window 16 is set flush with, or, as shown, recessed into, a raised tower 18 above the counter 14. The workstation 10 either rests directly on the counter 14, or preferably, rests in a cutout or well formed in the counter 14. Both the bed and tower windows 12, 16 are typically positioned to face and be accessible to a clerk 24 (FIG. 1) standing at one side of the counter 14 for enabling the clerk 24 to interact with the workstation 10. Alternatively, in a self-service checkout, the bed and tower windows 12, 16 are typically positioned to face and be accessible to a customer 20.

FIG. 1 also schematically depicts that a product staging area 102 is located on the counter 14 at one side of the workstation 10. The products are typically placed on the product staging area 102 by the customer 20 standing at the opposite side of the counter. The customer 20 typically retrieves the individual products for purchase from a shopping cart 22 or basket for placement on the product staging area 102. A non-illustrated conveyor belt could be employed for conveying the products to the clerk 24.

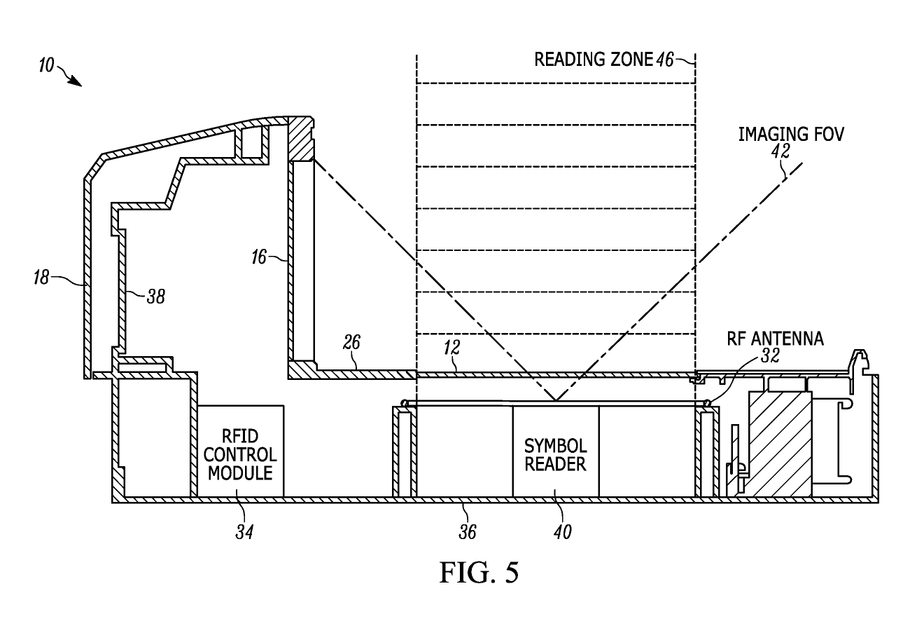

FIGS. 1 and 5 schematically depict that the workstation 10 has a bar code symbol reader 40, for example, a plurality of imaging readers, each including a solid-state imager for capturing light passing through either or both windows 12, 16 from a one- or two-dimensional symbol over an imaging field of view (FOV) 42. In typical use, the clerk 24 may process each product bearing a UPC symbol thereon, past the windows 12, 16 by swiping the product across a respective window, or by presenting the product by holding it momentarily steady at the respective window, before passing the product to a bagging area 104 that is located at the opposite side of the workstation 10. The symbol may be located on any of the top, bottom, right, left, front and rear, sides of the product, and at least one, if not more, of the imagers will capture the return light returning from the symbol through one or both windows 12, 16 as an image.

In accordance with this disclosure, an RFID reader 30 includes an RF antenna 32 for radiating RF energy, particularly in the industrial, scientific, and medical (ISM) frequency band of about 902 MHz to about 928 MHz, and integrated in the workstation 10. As shown in FIG. 5, the RFID reader 30 includes an RF control module 34 for controlling the RF antenna 32, especially its ERP. As described below, the RFID reader 30 detects return RF energy returning from RFID tags associated with the products passing through the workstation 10 past either or both windows 12, 16. Although the workstation 10 has been illustrated as a dual-window workstation, it will be understood that the readers 30, 40 could be installed in other types of workstations, for example, a flat bed scanner having a single horizontal window, or a vertical slot scanner having a single upright window.

As previously mentioned, either or both windows 12, 16 is transmissive to light, for example, is constituted of glass or plastic. In the case of imaging readers, an illumination source emits illumination light in one direction through the windows 12, 16, and the return illumination light that is reflected and/or scattered from the symbol passes in the opposite direction to the imagers. In the case of moving laser beam readers, a laser emits laser light in one direction through the windows 12, 16, and the return laser light that is reflected and/or scattered from the symbol passes in the opposite direction to a photodetector. Either or both windows 12, 16 is also transmissive to the RF energy radiated by the RF antenna 32 in one direction through the windows 12, 16, and to the return RF energy returning from the RFID tags in the opposite direction through the windows 12, 16 to the RF antenna 32.

The bed 26 and the tower 18 of the workstation 10 together comprise a housing or chassis for supporting the windows 12, 16. The housing has housing walls constituted of a material that blocks the light and reflects the RF energy, e.g., an electrically conductive material, such as metal. The housing may be in sheet or cast metal, such as aluminum, steel, zinc, magnesium, or a metal-coated structural member. As previously mentioned, such metal walls could attenuate, or sometimes even block, the RF interrogating and return waves, and degrade the RFID reader performance. However, in accordance with this disclosure, the metal walls are used to advantage, and the RF antenna 32 is positioned such that there is little, or no, degradation in the performance of the RFID reader.

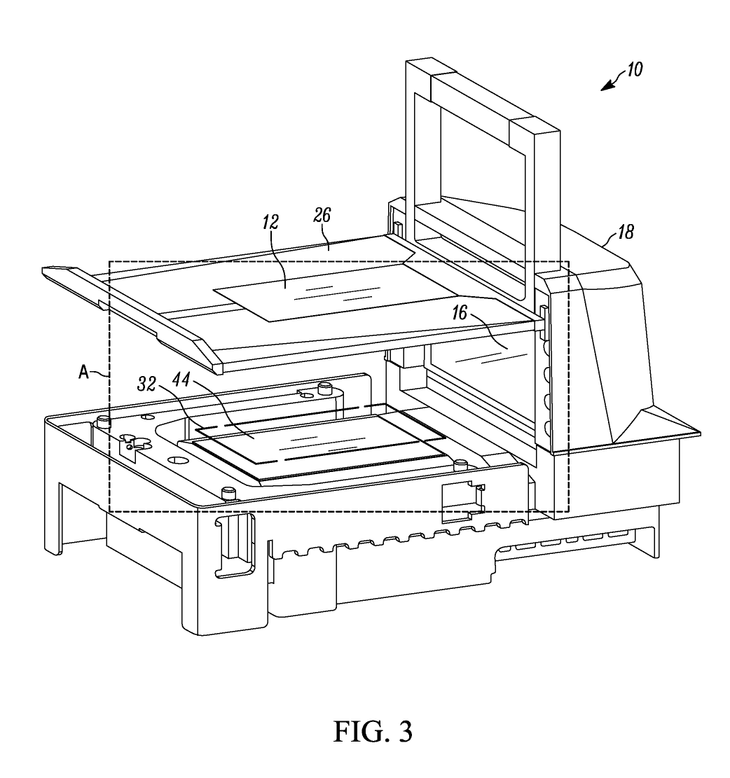

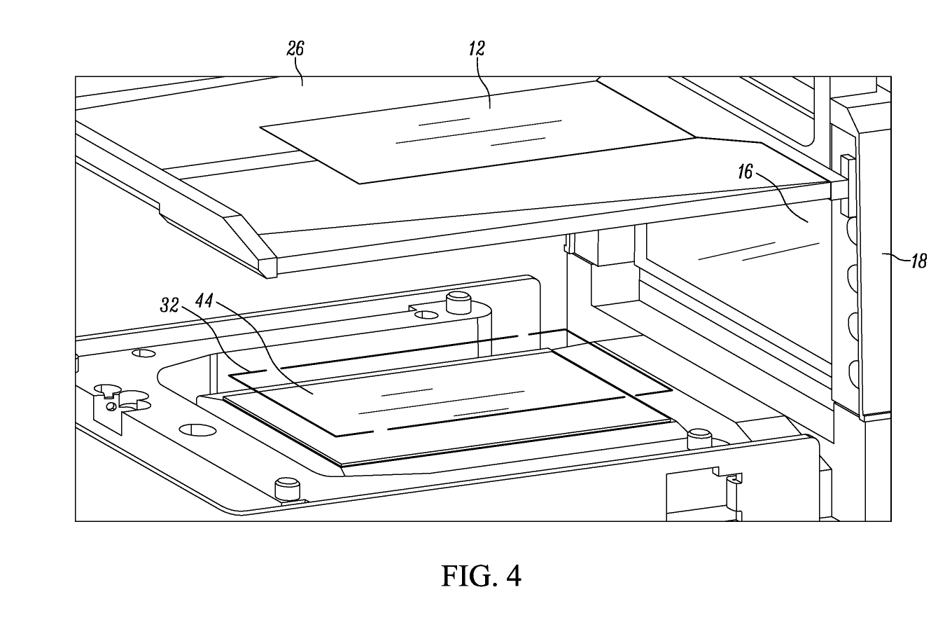

As shown in FIGS. 2-5, the RF antenna 32 is mounted underneath and behind the window 12. The RF antenna 32 is shown as a generally rectangular loop that is constituted of a flexible conductor, e.g., a metal wire of approximately 20 AWG (American Wire Gauge). The rectangular loop surrounds the window 12. Although the loop is illustrated as having a generally rectangular contour, it will be understood that the loop may have other contours, such as generally circular, oval, or other polygonal shapes. The RF antenna 32 need not be a loop, but can be a dipole, or any other RF radiator. The RF antenna 32 could also be a conductive strip applied on a printed circuit board.

The bed 26 and the window 12 bound an interior cavity or enclosure in which the RF antenna 32 is mounted. When the RF antenna 32 radiates RF energy, the RF energy initially fills the cavity, and then passes and spills out of the cavity through the non-metallic window 12. The metal walls of the bed 26 assist in reflecting the radiated RF energy along a direction that is generally perpendicular to the window 12. An RF reflector is advantageously provided underneath and behind the RF antenna 32 to assist in reflecting the radiated RF energy through the window 12. The RF reflector may be one of the electrically conductive housing walls, e.g., a generally planar, base or bottom wall 36 (see FIG. 5) of the bed 26, or may be a discrete, electrically conductive, generally planar, plate 44 mounted inside or outside the cavity behind and underneath the RF antenna 32. The plate 44 is constituted of an electrically conductive material, such as metal. The plate 44 may be in sheet or cast metal, such as aluminum, steel, zinc, magnesium, or a metal-coated structural member. The base wall 36 and the plate 44 are preferably parallel to the window 12, and serve to configure the RF antenna 32 as a directional antenna.

As an alternative, or in addition, to positioning the RF antenna 32 in a horizontal plane underneath the horizontal window 12, the RF antenna 32 can be positioned in a vertical plane behind the upright window 16. The metal walls of the tower 18 assist in reflecting the radiated RF energy along a direction that is generally perpendicular to the window 16. An RF reflector is advantageously provided behind the RF antenna 32 to assist in reflecting the radiated RF energy through the window 16. The RF reflector may be one of the electrically conductive housing walls, e.g., a generally planar, back or rear wall 38 (see FIG. 5) of the tower 18, or may be a discrete, electrically conductive, generally planar, plate, that is analogous to the plate 44. The back wall 38 and the plate are preferably parallel to the window 16, and serve to configure the RF antenna as a directional antenna.

The RF control module 34 controls, among other things, a transmit power of a transceiver connected to the RF antenna 32 to limit the effective radiated power (ERP) so that the RF antenna 32 radiates the RF energy over a reading zone of limited range, for example, less than ten inches, relative to either of the windows 12, 16. Unless so controlled, the RF reader might read RFID tags that are not of interest, for example, tags located on products on shelves in the venue. The RFID reader is thus controlled to read only tags of interest, i.e., tags in the workstation 10.

As also shown in FIG. 5, the symbol reader 40 is operative for reading the symbols over a reading field, such as the imaging field of view 42, and the RFID reader is operative for reading the RFID tags over a reading zone 46 that at least partly overlaps the imaging field of view 42. The RFID control module 34 is mounted either in the tower 18 so as to be hidden from view, or outside the workstation 10. The workstation 10 is operatively connected, either by a wired or a wireless connection, to a remote host server (not illustrated), and the data read by the symbol reader and/or by the RFID reader is advantageously sent to the host server over a shared, common connection to avoid having to install additional connectors on the workstation.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An arrangement for processing products associated with targets to be read, the arrangement comprising:
a window constituted of a material transmissive to light and to radio frequency (RF) electromagnetic energy;
a housing for supporting the window and having housing walls constituted of a material that reflects the RF energy;
an electro-optical reader supported by the housing and operative for reading the targets configured as bar code symbols by detecting return light returning from the symbols and passing through the window; and
an RF identification (RFID) reader including an RF antenna supported by the housing and operative for radiating the RF energy at a frequency greater than 900 MHz, the RFID reader being operative for reading the targets configured as RFID tags by directing the radiated RF energy reflected by the housing walls through the window away from the housing, and by detecting return RF energy returning from the tags toward the housing through the window.

2. The arrangement of claim 1, wherein the housing walls and the window bound an interior cavity in which the RF antenna is mounted, and wherein the material of the housing walls is electrically conductive to reflect the radiated RF energy from the interior cavity through the window.

3. The arrangement of claim 1, wherein the RF antenna is mounted behind the window.

4. The arrangement of claim 1, wherein the RF antenna is a loop that surrounds the window.

5. The arrangement of claim 1, and an RF reflector provided behind the RF antenna and operative for reflecting the radiated RF energy through the window along a direction that is generally perpendicular to the window.

6. The arrangement of claim 5, wherein the RF reflector is one of the electrically conductive housing walls.

7. The arrangement of claim 5, wherein the RF reflector is a discrete, electrically conductive plate.

8. The arrangement of claim 1, wherein the housing walls include a horizontal bed for supporting the window, and an upright raised tower for supporting another window that is also transmissive to the light and to the RF energy, and wherein the RF antenna is mounted behind at least one of the windows.

9. The arrangement of claim 1, wherein the RFID reader includes an RF control module for controlling an effective radiated power of the RF antenna to radiate the RF energy over a reading zone of limited range relative to the window.

10. The arrangement of claim 1, wherein the electro-optical reader is operative for reading the symbols over a reading field, and wherein the RFID reader is operative for reading the RFID tags over a reading zone that at least partly overlaps the reading field.

11. A method of processing products associated with targets to be read, the method comprising:
constituting a window of a material transmissive to light and to radio frequency (RF) electromagnetic energy;
supporting the window on a housing having housing walls;
constituting the housing walls of a material that reflects the RF energy;
reading the targets configured as bar code symbols with an electro-optical reader supported on the housing by detecting return light returning from the symbols and passing through the window; and
reading the targets configured as RFID tags with an RF identification (RFID) reader having an RF antenna supported on the housing by directing the RF energy radiated by the RF antenna at a frequency greater than 900 MHz and reflected by the housing walls through the window away from the housing, and by detecting return RF energy returning from the tags toward the housing through the window.

12. The method of claim 11, and mounting the RF antenna in an interior cavity bounded by the housing walls and the window, and constituting the material of the housing walls to be electrically conductive to reflect the radiated RF energy from the interior cavity through the window.

13. The method of claim 11, and mounting the RF antenna behind the window.

14. The method of claim 11, and configuring the RF antenna as a loop, and mounting the loop to surround the window.

15. The method of claim 11, and reflecting the radiated RF energy through the window along a direction that is generally perpendicular to the window by providing an RF reflector behind the RF antenna.

16. The method of claim 15, and constituting the RF reflector as one of the electrically conductive housing walls.

17. The method of claim 15, and constituting the RF reflector as a discrete, electrically conductive plate.

18. The method of claim 11, and configuring the housing walls to include a horizontal bed for supporting the window, and an upright raised tower for supporting another window that is also transmissive to light and to RF energy, and mounting the RF antenna behind at least one of the windows.

19. The method of claim 11, and controlling an effective radiated power of the RF antenna to radiate the RF energy over a reading zone of limited range relative to the window.

20. The method of claim 11, wherein the electro-optical reader is operative for reading the symbols over a reading field, and wherein the RFID reader is operative for reading the RFID tags over a reading zone, and at least partly overlapping the reading field and the reading zone.
